(19) United States
(12) Patent Application Publication
(10) Pub. No.: US 2026/0343083 A1
(43) Pub. Date: Oct. 29, 2026

(54) INFORMATION PROCESSING APPARATUS AND CONTROL METHOD

(71) Applicant: Lenovo Japan LLC, Tokyo (JP)

(72) Inventors: Xueyong Yang, Kanagawa (JP); Yasumichi Tsukamoto, Kanagawa (JP); Yuichi Onda, Kanagawa (JP)

(73) Assignee: Lenovo Japan LLC, Tokyo (JP)

(21) Appl. No.: 19/575,481

(22) Filed: Mar. 23, 2026

(30) Foreign Application Priority Data
Apr. 25, 2025 (JP) 2025-072859

(51) Int. Cl. H04N 23/611; H04N 23/20; H04N 23/667

(52) U.S. Cl. CPC H04N 23/611; H04N 23/20; H04N 23/667

(57) ABSTRACT

An information processing apparatus includes: an infrared camera including a light-emitting part configured to emit infrared light in a predetermined direction and a light-receiving part for receiving reflected light of the infrared light incident from the predetermined direction; a shutter configured to switch between a closed state to shield a side of the predetermined direction and an open state to open the side of the predetermined direction; and a processor configured to control the shutter upon facial recognition processing using the infrared camera. The processor performs shutter control processing in which, when the shutter is in the closed state before start of the facial recognition processing, the processor temporarily switches the shutter to the open state at the start of the facial recognition processing, and returns the shutter to the closed state upon completion of the facial recognition processing.

### CROSS-REFERENCE TO RELATED APPLICATIONS

This application claims priority to Japanese Patent Application No. 2025-072859 filed on Apr. 25, 2025, the contents of which are hereby incorporated herein by reference in their entirety.

### TECHNICAL FIELD

The present invention relates to an information processing apparatus and a control method.

### BACKGROUND

Information processing apparatuses such as laptop PCs (Personal Computers) equipped with built-in cameras are now popular. Among the information processing apparatuses equipped with built-in cameras, there is an information processing apparatus equipped with a privacy shutter (cover) capable of physically shielding the imaging direction of a built-in camera from the perspective of privacy protection or the like (for example, Japanese Unexamined Patent Application Publication No. 2023-084910).

However, this built-in camera may also be used for face authentication to allow login (sign-in) to a system. When a user shields the imaging direction of the camera by closing the privacy shutter, it is preferable from the perspective of privacy protection but the user cannot log in using face authentication because a face of the user using the information processing apparatus cannot be captured. Therefore, it is desired that login using face authentication can also be performed while considering privacy protection.

### SUMMARY

The present invention provides an information processing apparatus and a control method capable of enabling login using face authentication while considering the privacy protection of a built-in camera.

The information processing apparatus according to one or more embodiments of the present invention includes: an infrared camera including a light-emitting part configured to emit infrared light in a predetermined direction and a light-receiving part for receiving reflected light of the infrared light incident from the predetermined direction; a shutter configured to switch between a closed state to shield the side of the predetermined direction and an open state to open the side of the predetermined direction; and a processor configured to control the shutter upon facial recognition processing using the infrared camera, wherein the processor performs shutter control processing in which, when the shutter is in the closed state before the start of the facial recognition processing, the processor temporarily switches the shutter to the open state at the start of the facial recognition processing, and returns the shutter to the closed state upon completion of the facial recognition processing.

The above information processing apparatus may be such that the processor controls the settings of the infrared camera when performing the facial recognition processing to predetermined fixed values in response to temporarily switching the shutter to the open state by the shutter control processing.

The above information processing apparatus may also be such that, in response to temporarily switching the shutter to the open state by the shutter control processing, the processor controls a light-receiving time of the light-receiving part of the infrared camera when performing the facial recognition processing and a gain to amplify photoelectrically converted data of the light receiving amount of the light-receiving part to fixed values predetermined according to the light emission amount of the light-emitting part of the infrared camera.

The above information processing apparatus may further be such that, in the shutter control processing, when the shutter is in the open state before the start of the facial recognition processing, the processor keeps the shutter open from the start to end of the facial recognition processing, and does not control the light-receiving time and the gain to the fixed values so that the light-receiving time of the light-receiving part of the infrared camera when performing the facial recognition processing and the gain to amplify the photoelectrically converted data of the light receiving amount of the light-receiving part are controlled automatically.

Further, the above information processing apparatus may be such that the processor includes a first processor configured to execute at least the facial recognition processing and a second processor configured to execute at least the shutter control processing.

Further, the above information processing apparatus may be such that the first processor executes the facial recognition processing in login processing for logging in to an OS (Operating System) under the control of the OS.

Further, a control method for an information processing apparatus according to one or more embodiments of the present invention includes: an infrared camera including a light-emitting part configured to emit infrared light in a predetermined direction and a light-receiving part for receiving reflected light of the infrared light incident from the predetermined direction; a shutter configured to switch between a closed state to shield a side of the predetermined direction and an open state to open the side of the predetermined direction; and a processor configured to control the shutter upon facial recognition processing using the infrared camera, the control method including: a step of temporarily switching the shutter to the open state at the start of the facial recognition processing when the shutter is in the closed state before the start of the facial recognition processing; and a step of returning the shutter to the closed state upon completion of the facial recognition processing.

The above aspects of the present invention can enable login using face authentication while considering the privacy protection of a built-in camera.

### BRIEF DESCRIPTION OF THE DRAWINGS

FIG. 1 is a perspective view illustrating a configuration example of the appearance of an information processing apparatus according to one or more embodiments.

FIG. 2 is a diagram illustrating a control example of a privacy shutter (electric shutter) according to one or more embodiments.

FIG. 3 is an explanatory diagram illustrating an example of a delay in face authentication time when the electric shutter is temporarily open according to one or more embodiments.

FIG. 4 is a schematic diagram illustrating a comparison between an RGB camera and an IR camera according to one or more embodiments.

FIG. 5 is a graph illustrating a relationship of the light emission amount of an IR emitter with a gain and an exposure according to one or more embodiments.

FIG. 6 is a schematic block diagram illustrating an example of the hardware configuration of the information processing apparatus according to one or more embodiments.

FIG. 7 is a schematic block diagram illustrating an example of a configuration related to electric shutter control upon login authentication for the information processing apparatus according to one or more embodiments.

FIG. 8 is a flowchart illustrating an example of processing related to electric shutter control upon login authentication according to one or more embodiments.

### DETAILED DESCRIPTION

Embodiments of the present invention will be described below with reference to the accompanying drawings.

### Overview

First, the overview of an information processing apparatus according to one or more embodiments will be described.

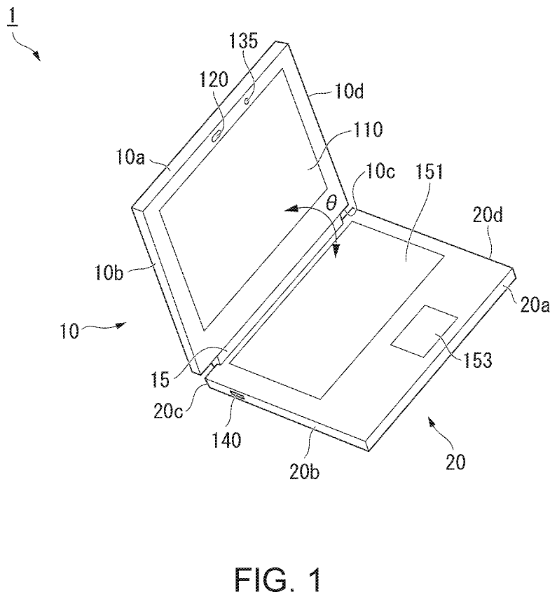

FIG. 1 is a perspective view illustrating a configuration example of the appearance of an information processing apparatus 1 according to one or more embodiments.

The information processing apparatus 1 is, for example, a laptop (clamshell) PC (Personal Computer). The information processing apparatus 1 includes a first chassis 10, a second chassis 20, and a hinge mechanism 15. The first chassis 10 and the second chassis 20 are joined by using the hinge mechanism 15. The first chassis 10 is rotatable around an axis of rotation formed by the hinge mechanism 15 relative to the second chassis 20. An open angle by the rotation between the first chassis 10 and the second chassis 20 is illustrated as “θ.”

The first chassis 10 is also called a display chassis because a display is installed thereon. The second chassis 20 is also called a system chassis because a system board is built therein. For example, since the first chassis 10 is closed or open relative to the second chassis 20 as the system-side chassis, the first chassis 10 can also be called a Lid-side chassis.

In the following description, faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” Right and left viewed from the front are referred to as “right” and “left,” respectively. Left side faces of the first chassis 10 and the second chassis 20 are referred to as side faces 10b and 20b, and right side faces are referred to as side faces 10d and 20d, respectively. Further, a state where the first chassis 10 and the second chassis 20 overlap each other and are completely closed (a state of θ=0°) is referred to as a “closed state.” Surfaces of the first chassis 10 and the second chassis 20 on the face-to-face sides in the closed state are referred to as respective “inner surfaces,” and surfaces opposite to the inner surfaces are referred to as “outer surfaces.” Further, a state opposite to the closed state, where the first chassis 10 and the second chassis 20 are open, is referred to as an “open state.”

The appearance of the information processing apparatus 1 in FIG. 1 illustrates an example of the open state. The open state is a state where the side face 10a of the first chassis 10 and the side face 20a of the second chassis 20 are separated. In the open state, the respective inner surfaces of the first chassis 10 and the second chassis 20 appear.

The open state is one of states where a user uses the information processing apparatus 1, and the information processing apparatus 1 is often used in a state where the open angle is typically about θ=100° to 130°. Note that the range of open angles θ to be the open state can be determined arbitrarily according to the range of angles rotatable by the hinge mechanism 15, or the like.

A display unit 110 is provided on the inner surface of the first chassis 10. The display unit 110 is configured to include a liquid crystal display (LCD) or an organic EL (Electro Luminescence) display, and the like. Further, an imaging unit 120 (camera) and an HPD sensor 135 are provided in a peripheral area of the display unit 110 on the inner surface of the first chassis 10. Note that the position of the imaging unit 120 and the position of the HPD sensor 135 illustrated in FIG. 1 are just an example, and the positions may be elsewhere as long as the imaging unit 120 and the HPD sensor 135 can be directed in a direction to face a display screen of the display unit 110.

In the open state, the imaging unit 120 images a predetermined imaging range in the direction to face the display screen of the display unit 110 (that is, in front of the information processing apparatus 1). The predetermined imaging range is an angle-of-view range defined by an image sensor included in the imaging unit 120 and an optical lens provided in front of the imaging surface of the image sensor. For example, the imaging unit 120 can capture an image including a person (user) present in front of (on the front side of) the information processing apparatus 1.

Here, the imaging unit 120 is configured to include an RGB camera and an IR (InfraRed) camera. The RGB camera is a camera for capturing an image using visible light, which is equipped with an RGB sensor. The RGB sensor is an image sensor in which R pixels provided with color filters to transmit R (red) wavelengths, G pixels provided with color filters to transmit G (green) wavelengths, and B pixel provided with color filters to transmit B (blue) wavelengths are arranged.

On the other hand, the IR camera is a camera for capturing an image using infrared light. The IR camera is equipped with an IR emitter as a light-emitting part to emit infrared light, and an IR sensor as a light-receiving part to receive the infrared light. As the IR emitter, for example, an LED (Light Emission Diode) to emit infrared light can be used. The IR sensor is an image sensor in which IR pixels capable of receiving reflected light of the infrared light emitted from the IR emitter are arranged. In the IR sensor, color filters to transmit infrared light wavelengths exist. The color filters to transmit infrared light wavelengths may also exist in a window open in front of the IR emitter and the IR sensor.

The HPD sensor 135 is an HPD (Human Presence Detection) sensor for detecting a person (user) present in front of (on the front side of) the information processing apparatus 1. For example, as the HPD sensor 135, a ToF (Time of Flight) sensor or a ranging sensor such as a radar can be applied.

Further, a power button 140 is provided on the side face 20b of the second chassis 20. The power button 140 is an operating element used by the user to give an instruction to power on or power off, make a transition from a standby state to a normal operating state, make a transition from the normal operating state to the standby state, or the like. The normal operating state is an operating state of a system capable of executing processing without being particularly limited, which corresponds, for example, to S0 state defined in the ACPI (Advanced Configuration and Power Interface) specification.

The standby state is a state in which at least part of system processing is limited. For example, the standby state is a state in which the system is locked. In the state where the system is locked, an image preset to make a content being processed invisible (for example, an image for screen lock) is displayed on the display unit. To release the lock, login (sign-in) to the system is required. Further, the standby state may be the standby state or a sleep state, Modern Standby in Windows (registered trademark) (corresponding to S0ix state), or a state corresponding to S3 state (sleep state) defined in the ACPI specification. S0ix state is a state corresponding to S0 Low Power Idle as extended S0 state defined in the ACPI specification, which is lower in power consumption than S0 state but is fast to return to S0 state. For example, the standby state is a state lower in power consumption than the normal operating state.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Further, a keyboard 151 and a touchpad 153 are provided on the inner surface of the second chassis 20 as input devices to accept user operation input. Note that a touch sensor may also be provided as an input device instead of or in addition to the keyboard 151 and the touchpad 153, or a mouse and an external keyboard may be connected. When the touch sensor is provided, an area corresponding to the display screen of the display unit 110 may be constructed as a touch panel for accepting operations. Further, a microphone through which voice is input may be included in the input devices.

Note that, in the closed state where the first chassis 10 and the second chassis 20 are closed, the display unit 110 and the imaging unit 120 provided on the inner surface of the first chassis 10, and the keyboard 151 and the touchpad 153 provided on the inner surface of the second chassis 20 are covered with each other's chassis surfaces, and put in a state of being disabled from fulfilling the functions.

When starting up from the power-off state or returning from the standby state to the normal operating state, the information processing apparatus 1 executes processing for login authentication to allow login (sign-in) to the system (for example, Windows (registered trademark) Hello). For login authentication, for example, PIN authentication to enter a PIN (Personal Identification Number) from the keyboard 151, face authentication to authenticate a user's face, fingerprint authentication to authenticate a user's fingerprint, or the like is used. Here, PIN authentication is time-consuming because it requires PIN input from the keyboard 151. Further, in the case of fingerprint authentication, an action to bring a registered finger into contact with a fingerprint sensor is required, and fingerprint authentication is not possible in the first place unless the fingerprint sensor is equipped. In contrast, since it is becoming common for information processing apparatuses such as laptop PCs to have built-in cameras so that face authentication can be performed by automatically detecting a user's face using a camera without any special operation, use of face authentication for login authentication is increasing.

On the other hand, there is an information processing apparatus with a built-in camera, which is equipped with a privacy shutter (cover) capable of physically shielding an imaging direction of the camera from the perspective of privacy protection, or the like. By closing the privacy shutter, unauthorized photography due to hacking can be prevented, and hence privacy can be protected. However, on the other hand, when the imaging direction of the camera is shielded by closing the privacy shutter, the user's face cannot be captured and login authentication by face authentication cannot be performed.

Therefore, in the information processing apparatus 1 according to one or more embodiments, an electrically openable/closable electric shutter is provided as a privacy shutter over the imaging unit 120, and when the privacy shutter is closed, the privacy shutter is controlled to temporarily open only during a login authentication (face authentication) period. For example, in the standby state, the detection of a person by the HPD sensor 135, input to an input device (HID: Human Interface Device) such as the keyboard 151 and the touchpad 153, or the like becomes a trigger for login authentication.

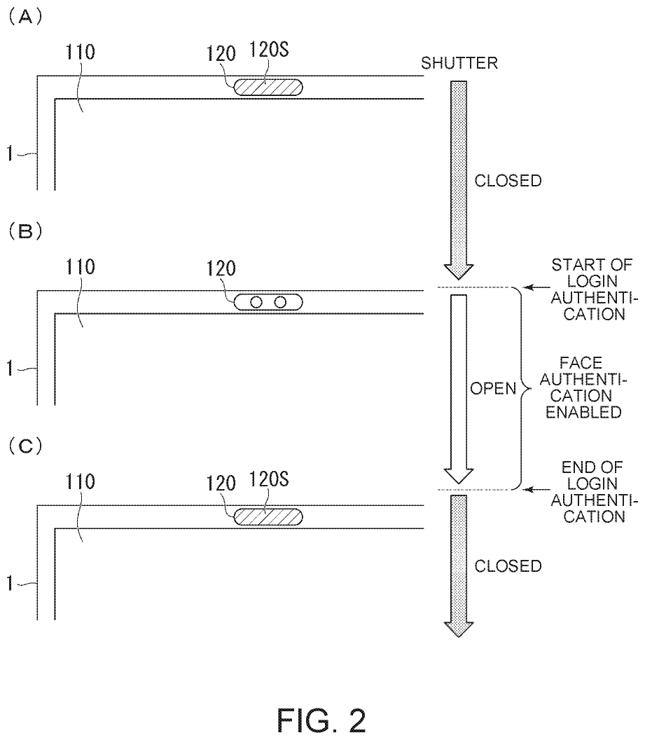

FIG. 2 is a diagram illustrating a control example of the privacy shutter (electric shutter) according to one or more embodiments. An electric shutter 120S as the privacy shutter is provided over the imaging unit 120 equipped as the built-in camera in the information processing apparatus 1. The electric shutter 120S is electrically controlled to switch between a closed state to physically shield the imaging direction side and an open state to open the imaging direction side.

For example, the electric shutter 120S is equipped with a cover member to be slid by a driving unit such as an actuator between a position to cover the front side of the imaging unit 120 and a position not to cover the front side thereof in order to switch between the closed state and the open state in response to a specific user operation. The specific user operation is a key operation to switch the electric shutter 120S between open and closed states. The key to be operated may be any of keys (for example, function keys) arranged on the keyboard 151, or may be an icon to be displayed on the display unit 110 as an operation icon.

FIG. 2(A) illustrates an example in which the user using the information processing apparatus 1 is keeping the electric shutter 120S closed from the perspective of privacy protection. When the electric shutter 120S is in the closed state at the start of login authentication, the information processing apparatus 1 temporarily opens the electric shutter 120S as illustrated in FIG. 2(B). This enables face authentication. After that, when the login authentication is completed by any of PIN authentication, face authentication, and fingerprint authentication, the information processing apparatus 1 closes the electric shutter 120S to return to the closed state.

Thus, when the user is closing the privacy shutter due to concern about privacy protection, the information processing apparatus 1 can enable login using face authentication by temporarily opening the privacy shutter only during the login authentication period while considering privacy protection.

However, since environmental conditions, such as brightness, under which an image is captured by the imaging unit 120 vary depending on location and time, exposure and gain are automatically adjusted under normal control. For example, as the exposure adjustment, the light-receiving time of the light-receiving part is adjusted. Further, as the gain adjustment, a gain value to amplify captured image data (digital data) is adjusted.

Therefore, in a case where the electric shutter 120S is temporarily open from the closed state (pitch black state), when the exposure and gain are automatically adjusted, it takes time to make the brightness of the captured image data of the imaging unit 120 appropriate, and there is a delay in the time it takes for face authentication to complete. Here, the appropriate brightness of the captured image data is brightness to enable face authentication.

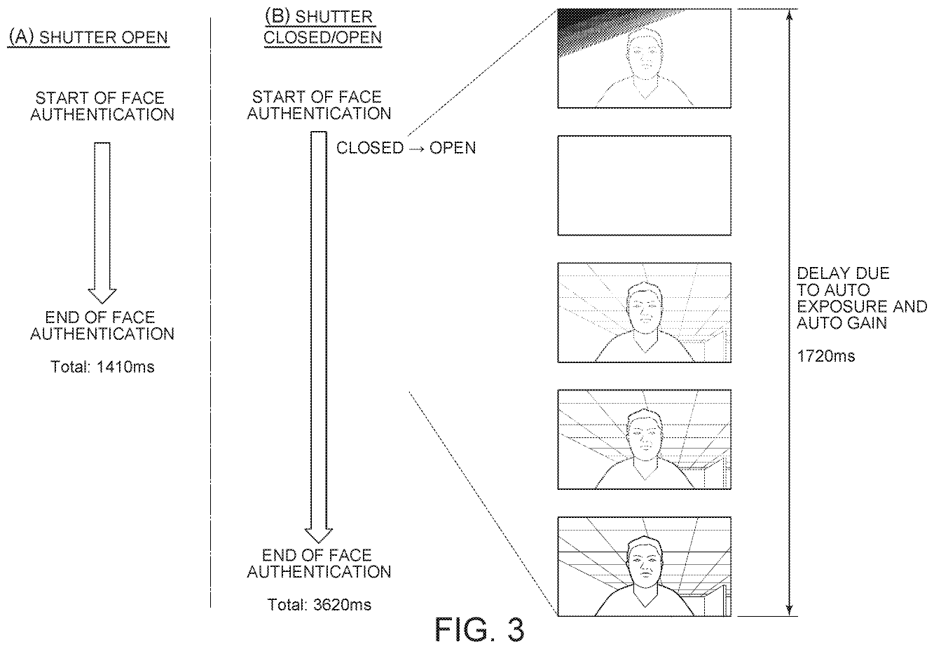

FIG. 3 is an explanatory diagram illustrating an example of a delay in face authentication time when the electric shutter 120S is temporarily open according to one or more embodiments. As illustrated in FIG. 3(A), when face authentication is performed in the state where the electric shutter 120S is open, it takes 1410 ms from start to end of the face authentication as an example. On the other hand, as illustrated in FIG. 3(B), when the electric shutter 120S is temporarily open from the closed state and the face authentication is performed, it takes 3620 ms from start to end of the face authentication as an example. When the electric shutter 120S is in the closed state (pitch black state), both values of auto exposure and auto gain are high because the captured image data is dark, and when the electric shutter 120S is opened, the captured image data comes out too bright. After that, the values of auto exposure and auto gain go down depending on the actual imaging environment to adjust the captured image data to the appropriate brightness in order to enable face authentication. As an example, the delay due to the auto exposure and the auto gain is 1720 ms.

Thus, in the case where the electric shutter 120S is temporarily opened only when performing face authentication, it takes longer to perform face authentication than the case when performing face authentication in the open state of the electric shutter 120S, and it is undesirable because there is a delay in the time it takes for face authentication to complete. Therefore, although the information processing apparatus 1 according to one or more embodiments includes the RGB camera and the IR camera in the imaging unit 120 as described above, the IR camera is used without using the RGB camera to perform face authentication by fixing both the exposure and the gain so as not to cause a delay due to the auto exposure and the auto gain.

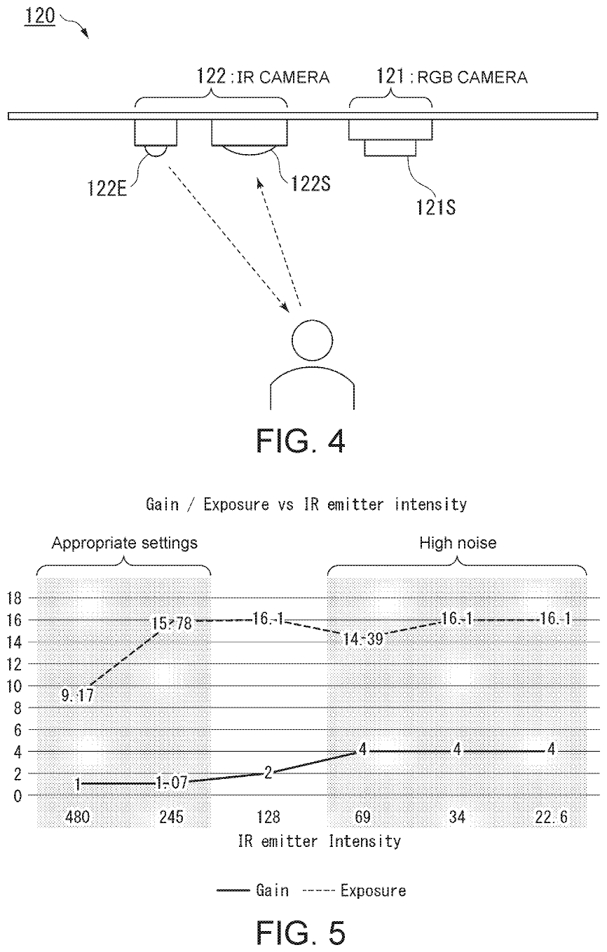

FIG. 4 is a schematic diagram illustrating a comparison between the RGB camera and the IR camera according to one or more embodiments. The imaging unit 120 is equipped with an RGB camera 121 for capturing an image using visible light, and an IR camera 122 for capturing an image using infrared light. Since the RGB camera 121 captures an image using an RGB sensor 121S that receives visible light, captured image data is affected by environmental brightness and required to be adjusted by auto exposure and auto gain.

On the other hand, the IR camera 122 captures an image in such a manner that an IR sensor 122S receives reflected light of infrared light emitted from an IR emitter 122E. Since the amount of infrared light emitted by the IR emitter 122E is a known value, the captured image data is less affected by environmental brightness. Therefore, when using the IR camera 122, captured image data with appropriate brightness can be obtained without performing auto exposure and auto gain.

Note that when the presence or absence of the user is detected using the IR camera 122, auto exposure and auto gain are performed because the detection range may be fairly wide, but when face authentication is performed in login authentication, the detection range can be limited to such a situation that the user is in the vicinity of the information processing apparatus 1. Therefore, face authentication can be performed by setting the exposure and gain values to fixed values predetermined according to the known amount of light emitted by the IR emitter 122E without performing auto exposure and auto gain.

Next, an example of the fixed values for setting the exposure and the gain according to the amount of light emission of the IR emitter 122E when performing face authentication using the IR camera 122 will be described with reference to FIG. 5.

FIG. 5 is a graph illustrating relationships of the amount of light emission of the IR emitter with the gain and the exposure.

In the graph illustrated in FIG. 5, the horizontal axis represents the intensity (light emission amount) of the IR emitter 122E, and the vertical axis represents setting values of the exposure and the gain. On the left side of the horizontal axis, since the amount of light emission of the IR emitter 122E can be set large and the gain can be set low, the settings are appropriate for face authentication with low noise. For example, the fixed values of the exposure and the gain can be set arbitrarily within a range of “appropriate Settings” illustrated in FIG. 5.

### Hardware Configuration of Information Processing Apparatus

The configuration of the information processing apparatus 1 according to one or more embodiments will be described in detail below.

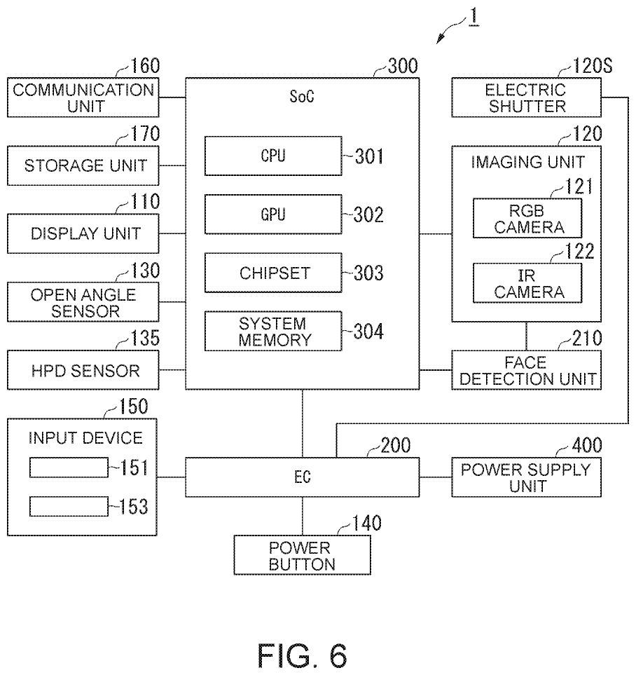

FIG. 6 is a schematic block diagram illustrating an example of the hardware configuration of the information processing apparatus 1 according to one or more embodiments. In FIG. 6, components corresponding to respective units in FIG. 1 are given the same reference numerals. The information processing apparatus 1 is configured to include the display unit 110, the imaging unit 120, the electric shutter 120S, an open angle sensor 130, the HPD sensor 135, the power button 140, an input device 150, a communication unit 160, a storage unit 170, an EC (Embedded Controller) 200, a face detection unit 210, an SoC (System on a chip) 300, and a power supply unit 400.

The display unit 110 displays display data (images) generated based on system processing executed by the SoC 300, processing of an application program(s) running on the system processing, and the like.

The imaging unit 120 captures an image of an object within a predetermined imaging range (angle of view) in the direction (frontward) to face the inner surface of the first chassis 10, and outputs the captured image to the SoC 300 and the face detection unit 210. As described above, the imaging unit 120 includes the RGB camera 121 and the IR camera 122.

The RGB camera 121 is a visible light camera for capturing an image using visible light, which is configured to include the RGB sensor 121S in which R pixels provided with color filters to transmit R (red) wavelengths, G pixels provided with color filters to transmit G (green) wavelengths, and B pixel provided with color filters to transmit B (blue) wavelengths are arranged as described above. The RGB camera 121 outputs, as captured image data, data of a visible light image obtained by photoelectrically converting the visible light incident from the imaging direction through the RGB color filters.

The IR camera 122 is an infrared camera for capturing an image using infrared light, which is configured to include the IR emitter 122E that emits infrared light in the imaging direction and the IR sensor 122S that receives light including reflected light of the infrared light incident from the imaging direction as described above. The IR camera 122 outputs, as captured image data, data of an infrared image obtained by photoelectrically converting the light including the reflected light of the infrared light incident from the imaging direction.

The electric shutter 120S electrically switches between the closed state to shield the imaging direction side of the imaging unit 120 and the open state to open the imaging direction side under the control of the EC.

The open angle sensor 130 is a sensor for detecting the open angle θ between the first chassis 10 and the second chassis 20. For example, the open angle sensor 130 may be composed of acceleration sensors respectively provided in the first chassis 10 and the second chassis 20.

The HPD sensor 135 is a sensor for detecting a person (user) present in front of (on the front side of) the information processing apparatus 1 as described above. The HPD sensor 135 outputs the detection result to the SoC 300. For example, HPD processing for detecting a person (user) present in front of (on the front side of) the information processing apparatus 1 using the HPD sensor 135 may be executed by the SoC 300, or the EC 200 may acquire the detection result of the HPD sensor 135 through the SoC 300 and execute the HPD processing.

The power button 140 outputs, to the EC 200, an operation signal according to a user operation. The input device 150 is an input unit that accepts user input, which is configured to include, for example, the keyboard 151 and the touchpad 153. In response to accepting operations on the keyboard 151 and the touchpad 153, the input device 150 outputs, to the EC 200, operation signals indicative of operation details.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SSD (Solid State Drive), a RAM (Random Access Memory), a ROM (Read Only Memory), and a flash ROM. The storage unit 170 stores an OS (Operating System), device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the SoC 300 to control the operation of the SoC 300 and manage the operating state of the SoC 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the SoC 300, an operation signal related to processing of the SoC 300 among the acquired operation signals.

Further, the EC 200 acquires sensor output from the open angle sensor 130 through the SoC 300 to detect the open angle θ between the first chassis 10 and the second chassis 20 based on the acquired sensor output of the open angle sensor 130. Further, the EC 200 controls the electric shutter 120S and sets the exposure and gain of the IR sensor 122S.

The face detection unit 210 is configured to include a processor that executes HPD processing by face detection based on a captured image captured by the imaging unit 120. The face detection unit 210 acquires the captured image captured by the imaging unit 120, and temporarily stores the acquired, captured image data in a memory. The memory in which the captured image data is stored may be a system memory 304, or an unillustrated memory in the face detection unit 210.

For example, the face detection unit 210 processes the captured image data acquired from the imaging unit 120 to detect a face area with a face captured therein from the captured image in order to detect the presence of a person. As the detection method of the face area, any detection method using a face detection algorithm for detecting a face based on facial feature information, trained data (learned model) subjected to machine learning based on the facial feature information, a face detection library, or the like can be applied.

Note that processing for face authentication in login authentication may be performed by the face detection unit 210 or performed by the SoC 300. For example, in the case of Windows (registered trademark) Hello, the SoC 300 executes face authentication processing. Further, in the case of a customized application rather than Windows (registered trademark) Hello, the face detection unit 210 may execute face authentication processing.

The SoC 300 is configured to include a CPU (Central Processing Unit) 301, a GPU (Graphic Processing Unit) 302, a chipset 303, and the system memory 304, where processing of various application programs is executable on the OS (Operating System) by system processing based on the OS.

The CPU 301 is a processor that executes processing based on a BIOS program, processing based on the OS program, processing based on application programs running on the OS, and the like. For example, the CPU 301 executes boot processing to boot the system from the standby state and make the transition to the normal operating state, sleep processing to make the transition from the normal operating state to the standby state, and the like.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200.

Further, the chipset 303 has a function as a sensor hub. For example, the chipset 303 is connected to the open angle sensor 130, the RGB sensor 121S, the IR sensor 122S, and the IR emitter 122E to communicate therewith. The chipset 303 may also be connected to the HPD sensor 135 to communicate therewith.

The system memory 304 is used as a reading area of a program executed by the CPU 301 and a working area to write processed data. Further, the system memory 304 temporarily stores captured image data captured by the imaging unit 120.

Note that the CPU 301, the GPU 302, and the chipset 303 may be integrated as one processor, or some or each of them may be configured as an individual processor, respectively. For example, in the normal operating state, the CPU 301, the GPU 302, and the chipset 303 are all operating, but in the standby state, for example, only at least part of the chipset 303 is operating.

### Configuration Related to Electric Shutter Control Upon Login Authentication

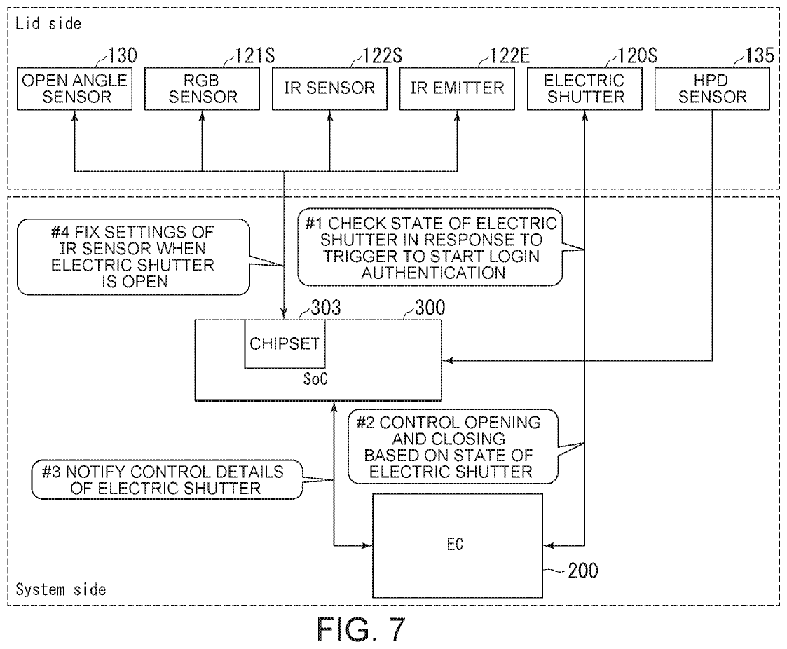

Next, a configuration in which the information processing apparatus 1 temporarily opens the electric shutter 120S upon login authentication to enable face authentication will be described in detail with reference to FIG. 7. In FIG. 7, components corresponding to respective units in FIG. 4 and FIG. 6 are given the same reference numerals.

FIG. 7 is a schematic block diagram illustrating an example of a configuration related to electric shutter control upon login authentication to the information processing apparatus 1 according to one or more embodiments. The open angle sensor 130, the RGB sensor 121S, the IR sensor 122S, the IR emitter 122E, and the electric shutter 120S are provided in the first chassis 10 on the Lid side. The EC 200 and the SoC 300 are provided in the second chassis 20 on the system side. The chipset 303 of the SoC 300 is connected to the open angle sensor 130, the RGB sensor 121S, the IR sensor 122S, and the IR emitter 122E. The EC 200 is connected to the SoC 300 and the electric shutter 120S. Further, the HPD sensor 135 is connected to the SoC 300.

The EC 200 checks the state of the electric shutter 120S in response to a trigger to start login authentication (#1). Here, the trigger to start login authentication is, for example, an event to return from the standby state, such as that a person is detected by the HPD sensor 135, that there is input to the input device (HID) like the keyboard 151 and the touchpad 153, or the like. Specifically, for example, return due to the fact that a person is detected by the HPD sensor 135 in S0ix state, or return due to the fact that there is input to the input device (HID) in S0ix state becomes the trigger to start login authentication. Note that return due to the fact that the first chassis 10 and the second chassis 20 are opened from the closed state in S4 state, or return due to the fact that there is input to the input device (HID) in S4 state also becomes the trigger to start login authentication. Further, return (boot) due to the fact that the power button 140 is operated in S5 state becomes the trigger to start login authentication as well.

Next, the EC 200 controls opening and closing based on the state of the electric shutter 120S (#2). For example, when the electric shutter 120S is in the open state, the EC 200 keeps it open, and when the electric shutter 120S is in the closed state, the EC 200 temporarily opens the electric shutter 120S. Further, the EC 200 notifies the SoC 300 of the control details of the electric shutter 120S (#3).

Based on the control details of the electric shutter 120S, when the electric shutter 120S is temporarily open, the chipset 303 sets the exposure and gain of the IR sensor 122S to the fixed values (#4).

### Operation of Processing

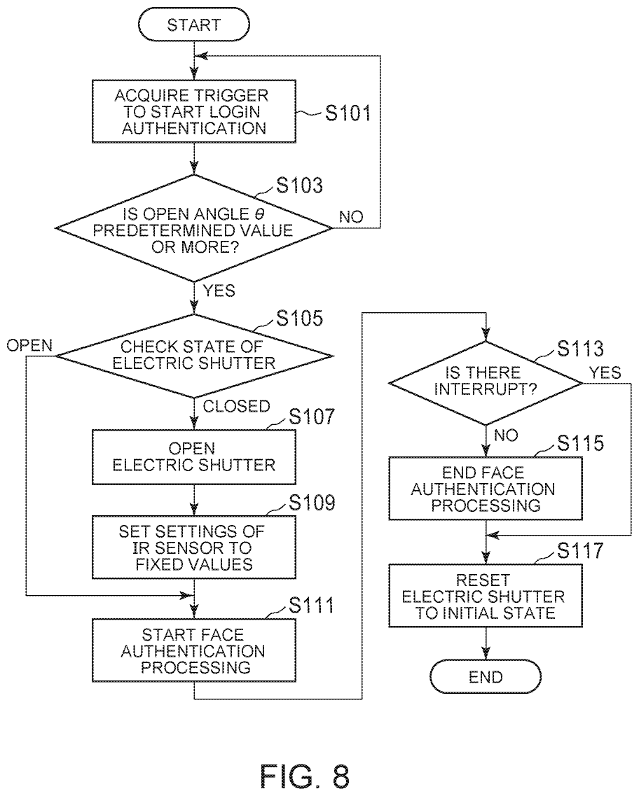

Next, the operation of processing in which the information processing apparatus 1 temporarily opens the electric shutter 120S upon login authentication to enable face authentication will be described with reference to FIG. 8.

FIG. 8 is a flowchart illustrating an example of processing related to electric shutter control upon login authentication according to one or more embodiments.

(Step S101) When acquiring a trigger to start login authentication, the EC 200 proceeds to a process in step S103.

(Step S103) The EC 200 detects an open angle θ between the first chassis 10 and the second chassis 20 based on Sensor output of the open angle sensor 130 to determine whether or not the open angle θ is a predetermined value or more. This predetermined value is a threshold value preset for determining whether or not the first chassis 10 and the second chassis 20 are open just enough to be able to capture an image of a user's face by the IR camera 122.

When determining that the open angle θ is not the predetermined value or more (step S103: NO), since the usage form disables login by face authentication, the EC 200 returns to the process in step S101. On the other hand, when determining that the open angle θ is the predetermined value or more (step S103: YES), the EC 200 proceeds to a process in step S105.

(Step S105) The EC 200 checks the state of the electric shutter 120S to determine whether the electric shutter 120S is in the open state or the closed state. When determining that the electric shutter 120S is in the closed state, the EC 200 temporarily opens the electric shutter 120S to make it open (step S107), and sets the exposure and gain of the IR sensor 122S to fixed values through the chipset 303 (step S109). Then, the procedure proceeds to a process in step S111.

On the other hand, when determining that the electric shutter 120S is in the open state, the EC 200 keeps the electric shutter 120S open and keeps the exposure and gain settings of the IR sensor 122S on auto, and the procedure processes to the process in step S111.

(Step S111) The SoC 300 starts face authentication processing using the IR camera 122. Then, the SoC 300 proceeds to a process in step S113.

(Step S113) The SoC 300 determines whether or not there is an interrupt in response to successful PIN authentication or fingerprint authentication other than face authentication. When determining that there is no interrupt (step S113: NO), the SoC 300 ends the face authentication processing due to the success of face authentication (step S115), and the procedure proceeds to a process in step S117. On the other hand, when there is an interrupt (step S113: YES), the procedure proceeds to the process in step S117.

(Step S117) The EC 200 resets the electric shutter 120S to an initial state. For example, when the state of the electric shutter 120S checked in step S103 is the closed state and the EC 200 temporarily opens the electric shutter 120S to make it open, the EC 200 returns the electric shutter 120S to the closed state. Note that the EC 200 sets the exposure and gain settings of the IR sensor 122S back to auto.

Further, when the state of the electric shutter 120S checked in step S103 is the open state and the open state is kept continuously after the start of login authentication, the EC 200 keeps the electric shutter 120S open continuously.

Note that when determining that the electric shutter 120S is in the open state, the EC 200 may proceed to the process in step S111 after setting the exposure and gain of the IR sensor 122S to the fixed values to start the face authentication processing.

As described above, the information processing apparatus 1 according to one or more embodiments includes the IR camera 122 (infrared camera), the electric shutter 122S (an example of a shutter), and the EC 200 (an example of a processor). The IR camera 122 has the IR emitter 122E (an example of a light-emitting part) that emits infrared light in the imaging direction (an example of a predetermined direction), and the IR sensor 122S (an example of a light-receiving part) that receives reflected light of infrared light incident from the imaging direction. The electric shutter 122S switches between the closed state to shield the imaging direction side and the open state to open the imaging direction side. The EC 200 controls the electric shutter 122S upon facial recognition processing using the IR camera 122. For example, when the electric shutter 122S is in the closed state before the start of the facial recognition processing, the EC 200 performs shutter control processing to temporarily switch the electric shutter 122S to the open state at the start of the facial recognition processing and to return the electric shutter 122S to the closed state upon completion of the facial recognition processing.

Thus, even when the privacy shutter (the electric shutter 122S) is closed, since it is temporarily opened only during a facial recognition processing period to enable facial recognition, the information processing apparatus 1 can enable login using face authentication while considering the privacy protection of the built-in camera. For example, when the privacy shutter (the electric shutter 122S) is closed, the information processing apparatus 1 can maintain privacy protection except during the login period using face authentication.

Further, the EC 200 controls the settings of the IR camera 122 to predetermined fixed values when performing the facial recognition processing in response to temporarily switching the electric shutter 122S to the open state by the shutter control processing mentioned above.

Thus, when performing the facial recognition processing by temporarily opening the electric shutter 122S, since the information processing apparatus 1 performs the facial recognition processing using the IR camera 122 in a state where the settings of the IR camera 122 are fixed, the information processing apparatus 1 can avoid a delay in login using face authentication. Therefore, the information processing apparatus 1 can reduce the login time using face authentication and improve user experience.

For example, in response to temporarily switching the electric shutter 122S to the open state by the shutter control processing mentioned above, the EC 200 performs control so that the light-receiving time of the IR sensor 122S of the IR camera 122 when performing the facial recognition processing and the gain to amplify photoelectrically converted data of the received light amount of the IR sensor 122S become fixed values predetermined according to the amount of light emission of the IR emitter 122E of the IR camera 122.

Thus, when performing the facial recognition processing by temporarily opening the electric shutter 122S, since the information processing apparatus 1 performs the facial recognition processing using the IR camera 122 in a state where the exposure and gain settings of the IR camera 122 are fixed, the information processing apparatus 1 can avoid a delay in login using face authentication. Therefore, the information processing apparatus 1 can reduce the login time using face authentication and improve user experience.

Further, in the shutter control processing mentioned above, when the electric shutter 122S is in the open state before the start of the facial recognition processing, the EC 200 keeps the electric shutter 122S open from the start to end of the facial recognition processing, and does not perform control to the fixed values so that the light-receiving time of the IR sensor 122S of the IR camera 122 when performing the facial recognition processing and the gain to amplify photoelectrically converted data of the received light amount of the IR sensor 122S are controlled automatically.

Thus, when the privacy shutter (the electric shutter 122S) is open, since the information processing apparatus 1 does not perform a special process in the facial recognition processing upon login, login using face authentication is enabled without adding any particular process.

Further, in the processor included in the information processing apparatus 1, the SoC 300 (an example of a first processor) configured to execute at least the facial recognition processing and the EC 200 (an example of a second processor) configured to execute at least the shutter control processing mentioned above are included.

Thus, when the privacy shutter (the electric shutter 122S) is closed, the information processing apparatus 1 is such that the SoC 300 can perform face authentication processing by temporarily opening the privacy shutter (the electric shutter 122S) under the control of the EC 200.

Further, the SoC 300 executes the facial recognition processing in login processing for logging in to the OS under the control of the OS.

Thus, when the privacy shutter (the electric shutter 122S) is closed, the information processing apparatus 1 is such that the SoC 300 can perform login processing using face authentication by temporarily opening the privacy shutter (the electric shutter 122S) under the control of the EC 200.

Further, a control method for an information processing apparatus 1 including: IR camera 122 (infrared camera) configured to have the IR emitter 122E (the example of the light-emitting part) that emits infrared light in the imaging direction (the example of the predetermined direction), and the IR sensor 122S (the example of the light-receiving part) that receives reflected light of infrared light incident from the imaging direction; the electric shutter 122S (the example of the shutter) configured to switch between the closed state to shield the imaging direction side and the open state to open the imaging direction side; and the EC 200 (the example of the processor) configured to control the electric shutter 122S upon facial recognition processing using the IR camera 122, the control method including: a step in which, when the electric shutter 122S is in the closed state before the start of the facial recognition processing, the EC 200 (the example of the processor) temporarily switches the electric shutter 122S to the open state at the start of the facial recognition processing; and a step of causing the EC 200 to return the electric shutter 122S to the closed state upon completion of the facial recognition processing.

Thus, even when the privacy shutter (the electric shutter 122S) is closed, since the information processing apparatus 1 temporarily opens the privacy shutter (the electric shutter 122S) only during the facial recognition processing period to enable facial recognition, the control method for the information processing apparatus 1 can enable login using face authentication while considering the privacy protection of the built-in camera. For example, when the privacy shutter (the electric shutter 122S) is closed, the control method for the information processing apparatus 1 can maintain privacy protection except during the login period using face authentication.

While one or more embodiments of this invention has been described in detail above with reference to the accompanying drawings, the specific configurations are not limited to those described above, and design changes and the like are included without departing from the scope of this invention. For example, the respective components described above in the embodiment can be combined arbitrarily.

Further, in the aforementioned one or more embodiments, the example in which the SoC 300 executes the facial recognition processing upon login is described, but the face detection unit 210 may also execute the facial recognition processing upon login.

Further, in the aforementioned one or more embodiments, the control of temporarily opening the privacy shutter (the electric shutter 122S) in the facial recognition processing upon login is described, but the control may also be applied to facial recognition processing other than that for login.

Further, in the aforementioned one or more embodiments, the example in which the face detection unit 210 is provided separately from the SoC 300 is given, but some or all of the functions of the face detection unit 210 may be provided in a processor integrated with the SoC 300. Further, some or all of the functions of the face detection unit 210 may be provided in the EC 200.

Further, in the aforementioned one or more embodiments, the example in which the CPU 301, the GPU 302, the chipset 303, and the system memory 304 are integrated and configured as the SoC 300 is described, but some of all of the components included in the SoC 300 may be individual components.

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 1, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network.

The above-mentioned program may also be to implement some of the functions described above. Further, the program may be a so-called a differential file (differential program) capable of implementing the above-described functions in combination with a program(s) already recorded in the computer system.

Further, some or all of the functions of the information processing apparatus 1 in the embodiment described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned one or more embodiments is not limited to the laptop PC, which may also be a desktop PC or the like, for example.

### DESCRIPTION OF SYMBOLS

1 information processing apparatus
10 first chassis
20 second chassis
15 hinge mechanism
110 display unit
120 imaging unit
120S electric shutter
121 RGB camera
122 IR camera
130 open angle sensor
135 HPD sensor
140 power button
150 input device
151 keyboard
153 touchpad
160 communication unit
170 storage unit
200 EC
210 face detection unit
300 Soc
301 CPU
302 GPU
303 chipset
304 system memory
400 power supply unit

What is claimed is:

1. An information processing apparatus comprising:
an infrared camera including a light-emitting part configured to emit infrared light in a predetermined direction and a light-receiving part for receiving reflected light of the infrared light incident from the predetermined direction;
a shutter configured to switch between a closed state to shield a side of the predetermined direction and an open state to open the side of the predetermined direction; and
a processor configured to control the shutter upon facial recognition processing using the infrared camera,
wherein the processor performs shutter control processing in which, when the shutter is in the closed state before start of the facial recognition processing, the processor temporarily switches the shutter to the open state at the start of the facial recognition processing, and returns the shutter to the closed state upon completion of the facial recognition processing.

2. The information processing apparatus according to claim 1, wherein the processor controls settings of the infrared camera when performing the facial recognition processing to predetermined fixed values in response to temporarily switching the shutter to the open state by the shutter control processing.

3. The information processing apparatus according to claim 2, wherein in response to temporarily switching the shutter to the open state by the shutter control processing, the processor controls a light-receiving time of the light-receiving part of the infrared camera when performing the facial recognition processing and a gain to amplify photoelectrically converted data of light receiving amount of the light-receiving part to fixed values predetermined according to light emission amount of the light-emitting part of the infrared camera.

4. The information processing apparatus according to claim 3, wherein in the shutter control processing, when the shutter is in the open state before the start of the facial recognition processing, the processor keeps the shutter open from start to end of the facial recognition processing, and is prohibited from controlling the light-receiving time and the gain to the fixed values so that the light-receiving time of the light-receiving part of the infrared camera when performing the facial recognition processing and the gain to amplify the photoelectrically converted data of the light receiving amount of the light-receiving part are controlled automatically.

5. The information processing apparatus according to claim 1, wherein the processor includes a first processor configured to execute at least the facial recognition processing and a second processor configured to execute at least the shutter control processing.

6. The information processing apparatus according to claim 5, wherein the first processor executes the facial recognition processing in login processing for logging in to an OS (Operating System) under control of the OS.

7. A control method for an information processing apparatus including: an infrared camera including a light-emitting part configured to emit infrared light in a predetermined direction and a light-receiving part for receiving reflected light of the infrared light incident from the predetermined direction; a shutter configured to switch between a closed state to shield a side of the predetermined direction and an open state to open the side of the predetermined direction; and a processor configured to control the shutter upon facial recognition processing using the infrared camera, the control method comprising:
a step of temporarily switching the shutter to the open state at the start of the facial recognition processing when the shutter is in the closed state before start of the facial recognition processing; and
a step of returning the shutter to the closed state upon completion of the facial recognition processing.
